(19) United States
(12) Patent Application Publication
(10) Pub. No.: US 2012/0283104 A1
(43) Pub. Date: Nov. 8, 2012

(54) Microcapsules containing pesticide and having polyvinyl monomers as cross-linking agents

(75) Inventors: Marc Rudolph Jung, Worms (DE); Tobias Joachim Koplin, Ludwigshafen (DE); Michael Krapp, Altrip (DE); Klaus Kolb, Schifferstadt (DE)

(73) Assignee: BASF SE, Ludwigshafen (DE)

(21) Appl. No.: 13/512,237

(22) PCT Filed: Nov. 25, 2010
(86) PCT No.: PCT/EP2010/068245

§ 371 Date: May 25, 2012

(30) Foreign Application Priority Data
Nov. 30, 2009 (EP) 09177493.5

(51) Int. Cl. A01N 25/28; A01P 7/02; A01P 21/00; A01N 57/00; A01P 13/00; A01P 7/04; A01P 3/00

(52) U.S. Cl. 504/359; 424/497; 514/75

(57) ABSTRACT

The present invention relates to microcapsules comprising a pesticide-containing capsule core and a capsule wall, and to a process for the preparation of these microcapsules. Furthermore, the invention relates to an agrochemical formulation comprising the microcapsules, and to the use of the microcapsules for controlling phytopathogenic fungi and/or undesired plant growth and/or undesired insect or mite infestation and/or for regulating the growth of plants.

The present invention relates to microcapsules comprising a pesticide-containing capsule core and a capsule wall, and also to a process for the preparation of these microcapsules. Furthermore, the invention relates to an agrochemical formulation comprising the microcapsules, and to the use of the microcapsules for controlling phytopathogenic fungi and/or undesired plant growth and/or undesired insect or mite infestation and/or for regulating the growth of plants. Combinations of preferred features with other preferred features are encompassed by the present invention.

Agrochemical active ingredients can be encapsulated by means of highly diverse methods. Thus, the capsule coatings can be based, for example, on polyurethane, acylurea or polyacrylates.

Microcapsules comprising a capsule core and a capsule wall that are based on polyacrylates are generally known:

WO 2008/071649 discloses microcapsules comprising a capsule core and a capsule wall, where the capsule wall is constructed from 30-90% by weight of alkyl esters of (meth)acrylic acid and/or (meth)acrylic acid and 10-70% by weight of a mixture of divinyl and polyvinyl monomers.

The pending European patent application EP 09165134.9 discloses microcapsules comprising a capsule core and a capsule wall, where the capsule wall is constructed from 50-90% by weight of alkyl esters of (meth)acrylic acid and 10-50% by weight of a mixture of divinyl and polyvinyl monomers.

The known microcapsules made of polyurethane or polyacrylates have various disadvantages, such as very rapid release of the capsule core.

It was therefore an object of the present invention to provide pesticide-containing microcapsules which permit a slow and uniform release of the pesticide.

The object is achieved by microcapsules comprising a pesticide-containing capsule core and a capsule wall, where the capsule wall is constructed from
30 to 90% by weight of one or more C₁-C₂₄-alkyl esters of acrylic acid and/or methacrylic acid, acrylic acid, methacrylic acid and/or maleic acid (monomers I),
10 to 70% by weight of one or more polyvinyl monomers (monomer II), and
0 to 30% by weight of one or more further monomers (monomer III), which are different from the monomers I,

in each case based on the total weight of the monomers.

The average particle size of the capsules (number-average by means of light scattering) is 1 to 50 μm. According to one preferred embodiment, the average particle size of the capsules is 1.5 to 15 μm, preferably 4 to 10 μm. Here, preferably 90% of the particles have a particle size of less than twice the average particle size.

The weight ratio of capsule core to capsule wall is in most cases in the range from 50:1 to 1:1, preferably from 20:1 to 2:1, and in particular from 20:1 to 4:1.

The polymers of the capsule wall generally comprise at least 30% by weight, in preferred form at least 35% by weight and in particularly preferred form at least 40% by weight, and in general at most 90% by weight, preferably at most 80% by weight and in particularly preferred form at most 75% by weight, of C₁-C₂₄-alkyl esters of acrylic acid and/or methacrylic acid, acrylic acid, methacrylic acid and/or maleic acid (monomers I) in copolymerized form, based on the total weight of the monomers.

According to the invention, the polymers of the capsule wall generally comprise at least 10% by weight, preferably at least 15% by weight, preferably at least 20% by weight, and in general at most 70% by weight, preferably at most 60% by weight and in particularly preferred form at most 50% by weight, of polyvinyl monomers (monomers II) in copolymerized form, based on the total weight of the monomers.

In addition, the polymers can comprise up to 30% by weight, preferably up to 20% by weight, in particular up to 10% by weight, particularly preferably up to 5% by weight, and at least 1% by weight, of further monomers III, preferably monomers IIIa, in copolymerized form, based on the total weight of the monomers.

Preferably, the capsule wall is constructed only from monomers of groups I and II.

Suitable monomers I are C₁-C₂₄-alkyl esters of acrylic acid and/or methacrylic acid (monomers Ia). Also suitable are the unsaturated C₃- and C₄-carboxylic acids, such as acrylic acid, methacrylic acid, or maleic acid (monomers Ib). Particularly preferred monomers I are methyl acrylate, ethyl acrylate, n-propyl acrylate and n-butyl acrylate and/or the corresponding methacrylates. Preference is given to isopropyl acrylate, isobutyl acrylate, sec-butyl acrylate and tert-butyl acrylate and the corresponding methacrylates. In general, the methacrylates and methacrylic acid are preferred.

Monomer I preferably comprises both monomers la and also monomers Ib. Particular preference is given to mixtures of monomer Ia (such as methyl methacrylate or C₁-C24-alkyl esters of acrylic acid) with methacrylic acid or acrylic acid. The weight ratio of monomer Ia to monomer Ib is in most cases in the range from 10:1 to 1:10, preferably from 6:1 to 1:8, in particular from 2:1 to 1:3.

According to one preferred embodiment, the microcapsule walls comprise 15% by weight to 70% by weight, preferably 20 to 50% by weight, of maleic acid and/or acrylic acid, in particular methacrylic acid.

Suitable polyvinyl monomers are the polyesters of polyols with acrylic acid and/or methacrylic acid, also the polyallyl and polyvinyl ethers of these polyols. Preference is given to trimethylolpropane triacrylate and trimethacrylate, pentaerythritol triallyl ether, pentaerythritol tetraalkyl ether, pentaerythritol triacrylate and pentaerythritol tetraacrylate, and their technical-grade mixtures.

Suitable further monomers III are monomers which are different from the monomers I and II. Examples are vinyl acetate, vinyl propionate, vinyl pyridine and styrene or α-methylstyrene. Particular preference is given to charge-carrying or ionizable-group-carrying monomers IIIa which are different from the monomers I and II, such as itaconic acid, maleic anhydride, 2-hydroxyethyl acrylate and methacrylate, acrylamido-2-methylpropanesulfonic acid, methacrylonitrile, acrylonitrile, methacrylamide, N-vinylpyrrolidone, N-methylolacrylamide, N-methylolmethacrylamide, dimethyiaminoethyl methacrylate and diethylaminoethyl methacrylate.

Monomers III preferably comprise precisely one ethylenically unsaturated group (such as vinyl or acrylic groups). Monomers III are preferably free from di- or polyvinyl monomers; they particularly preferably comprise at most 5.0% by weight, in particular at most 1.0% by weight, and specifically at most 0.1% by weight, of divinyl monomers.

Preferably, the capsule wall is constructed from
30 to 90% by weight of a mixture of monomers Ia and Ib, where the fraction of the monomers Ib is 15 to 70% by weight, based on the total weight of all of the monomers I, II and III,
10 to 70% by weight of monomer II, and
0 to 30% by weight of further monomers III,

in each case based on the total weight of the monomers.

The microcapsules according to the invention can be prepared by a so-called in-situ polymerization. The principle of microcapsule formation is based on the fact that the monomers, a free-radical initiator, a protective colloid and the pesticide to be encapsulated are used to prepare a stable oil-in-water emulsion. Preferably, the pesticide is dissolved in the nonpolar solvent in the emulsion. The polymerization of the monomers is then triggered by heating and, where necessary, it is controlled by further increasing the temperature, and the polymers that are produced form the capsule wall which surrounds the pesticide. This general principle is described, for example, in DE-A-10 139 171, to the contents of which reference is expressly made.

The present invention therefore also provides a process for the preparation of the microcapsules according to the invention in which monomers, free-radical initiator, protective colloid and the pesticide to be encapsulated are used to prepare an oil-in-water emulsion, and the polymerization of the monomers is triggered by heating and, where necessary, controlled by further increasing the temperature.

As a rule, the microcapsules are prepared in the presence of at least one organic or inorganic protective colloid. Both organic and inorganic protective colloids may be ionic or neutral. Protective colloids can be used here either individually or else in mixtures of two or more identically or differently charged protective colloids.

Organic protective colloids are preferably water-soluble polymers which lower the surface tension of the water from 73 mN/m maximum to 45 to 70 mN/m and thus ensure the formation of closed capsule walls and also form microcapsules with preferred particle sizes in the range from 0.5 to 50 μm, preferably 0.5 to 30 μm, in particular 0.5 to 10 μm.

Organic neutral protective colloids are, for example, cellulose derivatives, such as hydroxyethylcellulose, methylhydroxyethylcellulose, methylcellulose and carboxymethylcellulose, polyvinylpyrrolidone, copolymers of vinylpyrrolidone, gelatin, gum arabic, xanthanum, casein, polyethylene glycols, polyvinyl alcohol and partially hydrolyzed polyvinyl acetates, and also methylhydroxypropylcellulose. Preferred organic neutral protective colloids are polyvinyl alcohol and partially hydrolyzed polyvinyl acetates, and also methylhydroxypropylcellulose.

Organic anionic protective colloids are sodium alginate, polymethacrylic acid and its copolymers, the copolymers of sulfoethyl acrylate and methacrylate, sulfopropyl acrylate and methacrylate, of N-(sulfoethyl)maleimide, of 2-acrylamido-2-alkylsulfonic acids, styrenesulfonic acid and also of vinylsulfonic acid. Preferred organically anionic protective colloids are naphthalenesuifonic acid and naphthalenesulfonic acid-formaldehyde condensates, and in particular polyacrylic acids and phenolsulfonic acid-formaldehyde condensates.

Inorganic protective colloids to be mentioned are so-called Pickering systems, which permit a stabilization as a result of very fine solid particles and are insoluble but dispersible in water or are insoluble and nondispersible in water, but wettable by the pesticide or the nonpolar solvent. The mode of action and their use is described in EP-A-1 029 018 and EP-A-1 321 182, to the contents of which reference is expressly made.

Preference is given to using organic protective colloids, optionally in a mixture with inorganic protective colloids.

In general, the protective colloids are used in amounts of from 0.1 to 15% by weight, preferably from 0.5 to 10% by weight, based on the water phase. For inorganic protective colloids, preferably amounts of from 0.5 to 15% by weight, based on the water phase, are selected here. Organic protective colloids are preferably used in amounts of from 0.1 to 10% by weight, based on the water phase of the emulsion.

According to one embodiment, preference is given to inorganic protective colloids and their mixtures with organic protective colloids. According to a further embodiment, organically neutral protective colloids are preferred. Particular preference is given to protective colloids carrying OH groups, such as polyvinyl alcohols and partially hydrolyzed polyvinyl acetates.

In general, polyvinyl alcohol and/or partially hydrolyzed polyvinyl acetate are used in a total amount of at least 3% by weight, based on the microcapsules (without protective colloid). In most cases, at most 15% by weight of polyvinyl alcohol are used. It is possible here to add further aforementioned protective colloids in addition to the preferred amounts of polyvinyl alcohol or partially hydrolyzed polyvinyl acetate. Preferably, the microcapsules are prepared only with polyvinyl alcohol and/or partially hydrolyzed polyvinyl acetate and without the addition of further protective colloids.

According to a further embodiment, mixtures of organic protective colloids such as polyvinyl alcohols together with cellulose derivatives are preferred.

Polyvinyl alcohol is obtainable by polymerizing vinyl acetate, optionally in the presence of comonomers, and hydrolyzing the polyvinyl acetate with the elimination of the acetyl groups to form hydroxyl groups. The degree of hydrolysis of the polymers can be, for example, 1 to 100% and is preferably in the range from 50 to 100%, in particular from 65 to 95%. Within the context of this application, partially hydrolyzed polyvinyl acetates are to be understood as meaning a degree of hydrolysis of <50%, and polyvinyl alcohol is to be understood as meaning ≧50 to 100%. The preparation of homopolymers and copolymers of vinyl acetate, and the hydrolysis of these polymers to form polymers comprising vinyl alcohol units is generally known. Polymers comprising vinyl alcohol units are sold, for example, as Mowiolo grades from Kuraray Specialities Europe (KSE). Preference is given to polyvinyl alcohols and/or partially hydrolyzed polyvinyl acetates, whose viscosity of a 4% strength by weight aqueous solution at 20° C. in accordance with DIN 53015 has a value in the range from 3 to 56 mPa·s, preferably a value from 14 to 45 mPa·s. Preference is given to polyvinyl alcohols with a degree of hydrolysis of ≧65%, preferably ≧70%, in particular ≧75%.

The use of polyvinyl alcohol and/or partially hydrolyzed polyvinyl acetate leads to stable emulsions even in the case of a small average droplet size.

Usually, the size of the oil droplets almost corresponds with the size of the microcapsules present following the polymerization.

Free-radical initiators which can be used for the free-radical polymerization reaction are the customary peroxo and azo compounds, expediently in amounts of from 0.2 to 5% by weight, based on the weight of the monomers. Depending on the state of aggregation of the free-radical initiator and its solubility behavior, it can be introduced as such, but preferably as solution, emulsion or suspension, through which in particular small quantitative amounts of free-radical initiator can be dosed more precisely.

Preferred free-radical initiators to be mentioned are tert-butyl peroxoneodecanoate, tert-amyl peroxypivalate, dilauroyl peroxide, tert-amyl peroxy-2-ethylhexanoate, 2,2′-azobis(2,4-dimethyl)valeronitrile, 2,2′-azobis(2-methylbutyronitrile), dibenzoyl peroxide, tert-butyl per-2-ethylhexanoate, di-tert-butyl peroxide, tert-butyl hydroperoxide, 2,5-dimethyl-2,5-di(tert-butylperoxy)hexane and cumene hydroperoxide. Particularly preferred free-radical initiators are di(3,5,5-trimethylhexanoyl)peroxide, 4,4′-azobisisobutyronitrile, tert-butyl perpivalate and dimethyl 2,2-azobisisobutyrate. These have a half-life of 10 hours in a temperature range from 30 to 100° C.

Furthermore, it is possible to add regulators known to the person skilled in the art in customary amounts to the polymerization, such as tert-dodecyl mercaptan or ethylhexyl thioglycolate.

As a rule, the polymerization is carried out at 20 to 100° C., preferably at 40 to 95° C. A customary process variant is a reaction temperature starting at 60° C. which is increased to 85° C. in the course of the reaction. Advantageous free-radical initiators have a 10-hour half-life in the range from 45 to 65° C., such as t-butyl perpivalate. According to a further process variant, a temperature program is selected which starts at correspondingly higher reaction temperatures. For starting temperatures around 85° C., preference is given to free-radical initiators with a 10-hour half-life in the range from 70 to 90° C., such as t-butyl per-2-ethylhexanoate.

The polymerization is expediently carried out at atmospheric pressure, although it is also possible to work at reduced or slightly increased pressure, for example at a polymerization temperature above 100° C., thus about in the range from 0.5 to 5 bar. The reaction times for the polymerization are normally 1 to 10 hours, in most cases 2 to 5 hours.

One process variant according to the invention using polyvinyl alcohol and/or partially hydrolyzed polyvinyl acetate permits an advantageous procedure according to which dispersion and polymerization are carried out directly at elevated temperature.

In this way, it is possible to prepare microcapsules with a desired average particle size, it being possible to adjust the particle size in a manner known per se via the shear force, the stirring speed, and its concentration.

After the actual polymerization reaction, for a conversion of 90 to 99% by weight, it is generally advantageous to arrange for the aqueous microcapsule dispersions to be largely free from odor carriers, such as residual monomers and other volatile organic constituents. This can be achieved in manner known per se by physical means through distillative removal (in particular by a steam distillation) or by stripping off with an inert gas. In addition, it can take place by chemical means, as described in WO 99/24525, advantageously by redox-initiated polymerization, as described in DE-A 44 35 423, DE-A 44 19 518 and DE-A 44 35 422.

Moreover, in order to reduce the residual monomer content, according to one embodiment, the renewed addition of a free-radical initiator is required, which defines the start of the afterpolymerization. According to one preferred embodiment, after the capsule formation, an afterpolymerization is triggered with salts of peroxodisulfuric acid as free-radical initiator. Suitable salts are in particular ammonium, sodium and potassium peroxodisulfuric acid. The alkali metal salts of peroxodisulfuric acid are water-soluble and initiate the afterpolymerization in and/or from the water phase. The salts of peroxodisulfuric acid are expediently used in amounts of from 0.2 to 5% by weight, based on the weight of the monomers. Here, it is possible to meter them in all at once or over a certain period. The temperature for the afterpolymerization is usually 60 to 100° C. The afterpolymerization time is generally 0.5 to 5 hours.

According to this preferred embodiment with an afterpolymerization with one or more salts of the peroxodisulfuric acid as free-radical initiator, particularly low-odor microcapsules are obtained. If required, the afterpolymerization can also be carried out at even lower temperatures by adding reducing agents such as sodium bisulfite. The addition of reducing agents can further reduce the residual monomer content. Compared with customary afterpolymerization initiators consisting of organic, water-soluble peroxo or azo compounds such as Cert-butyl hydroperoxide, the rate of decomposition of which can, where necessary, be increased by adding a reducing agent such as ascorbic acid, the salts of peroxodisulfuric acid exhibit in the end product significantly lower amounts of odor carriers such as, for example, aldehydes.

The microcapsules according to the invention can be processed directly as aqueous microcapsule dispersion or in the form of a powder. Preferably, the microcapsules are present in the form of an aqueous dispersion.

The term agrochemical active ingredient (also called pesticides) refers to at least one active ingredient selected from the group of fungicides, insecticides, nematicides, herbicides, safeners and/or growth regulators. Preferred agrochemical active ingredients are fungicides, insecticides, herbicides and growth regulators. Mixtures of agrochemical active ingredients from two or more of the aforementioned classes can also be used. The person skilled in the art is familiar with such pesticides, which can be found, for example, in Pesticide Manual, 14th Ed. (2006), The British Crop Protection Council, London. Suitable insecticides are insecticides from the class of the carbamates, organophosphates, organochlorine insecticides, phenylpyrazoles, pyrethroids, neonicotinoids, spinosyns, avermectins, milbemycins, juvenile hormone analogs, alkyl halides, organotin compounds, nereistoxin analogs, benzoylureas, diacylhydrazines, METI acaricides, and also insecticides such as chloropicrin, pymetrozin, flonicamid, clofentezin, hexythiazox, etoxazole, diafenthiuron, propargite, tetradifon, chlorfenapyr, DNOC, buprofezin, cyromazin, amitraz, hydramethylnon, acequinocyl, fluacrypyrim, rotenone, or derivatives thereof. Suitable fungicides are fungicides from the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzylcarbamates, carbamates, carboxamides, carboxylic acid amides, chioronitriles, cyanoacetamide oximes, cyanoimidazoles, cyclopropanecarboxamides, dicarboxim ides, dihydrodioxazines, dinitrophenyicrotonates, dithiocarbamates, dithiolanes, ethylphosphonates, ethylaminothiazolecarboxamides, guanidines, hydroxy(2-amino)pyrimidines, hydroxyanilides, imidazoles, imidazolinones, inorganics, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chiorocarboxylic acids, cyclohexanediones, dinitroanilines, dinitrophenols, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic aicds, phosphoroamidates, phosphorodithioates, phthalamates, pyrazoles, pyridazinones, pyridines, pyridine carboxylic acids, pyridinecarboxamides, pyrimidinediones, pyrimidinyl (thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

Preferred pesticides dissolve to give a clear solution at 25° C. to at least 10 g/l, preferably at least 100 g/l and in particular at least 200 g/l, in an aromatic hydrocarbon mixture with an initial boiling point (IBP, in accordance with ASTM D86) of at least 225° C. (such as Solvesso® 200). Particularly preferred pesticides are metazachlor and pyraclostrobin.

The pesticide is preferably present in dissolved form in the capsule core. This means that preferably at least 90% by weight, in particular at least 98% by weight, of the pesticide is present in dissolved form 24 h after the preparation of the microcapsules.

The pesticide-containing capsule core usually comprises pesticide. Preferably, the capsule core additionally comprises a nonpolar solvent. Suitable nonpolar solvents are soluble in water at 20° C. at most to 10% by weight, preferably to at most 3% by weight, and in particular to at most 0.5% by weight. Examples are aromatics, aliphatics, vegetable oils and esters of vegetable oils.

Examples of aromatics are benzene, toluene, xylene, naphthalene, biphenyl, o- or m-terphenyl, mono- or poly-C₁-C₂₀-alkyl-substituted aromatic hydrocarbons, such as dodecyibenzene, tetradecylbenzene, hexadecylbenzene, methylnaphthalene, diisopropylnaphthalene, hexylnaphthalene or decylnaphthalene. Also suitable are technical-grade aromatics mixtures in the boiling range from 30 to 280° C., and also mixtures of the aforementioned aromatics. Preferred aromatics are technical-grade aromatic mixtures in the boiling range from 30 to 280° C.

Examples of aliphatics are saturated or unsaturated C₁₀-C₄₀-hydrocarbons which are branched or preferably linear, such as, for example, n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, n-octacosane, cyclic hydrocarbons, e.g. cyclohexane, cyclooctane, cyclodecane, mineral oils comprising saturated hydrocarbons, or mineral oil subjected to high-pressure hydrogenation (so-called white oils). Also suitable are mixtures of the aforementioned aliphatics. Preferred aliphatics are mineral oils.

Examples of vegetable oils and esters of vegetable oils are rapeseed oil, soybean oil, palm oil, sunflower oil, corn kernel oil, linseed oil, colza oil, olive oil, cotton seed oil, rapeseed oil methyl ester, rapeseed oil ethyl ester, and mixtures of vegetable oils, of esters of vegetable oils or of the two.

The weight ratio of nonpolar solvent to pesticide is in most cases in the range 1:20 to 20:1, preferably 1:10 to 8:1, and particularly preferably 1:8 to 4:1.

The invention also provides an agrochemical formulation comprising the microcapsules according to the invention, where the microcapsules are suspended in aqueous solution. The content of pesticide which is present in the pesticide-containing capsule core is in most cases 10 to 600 g per liter of agrochemical formulation, preferably 50 to 400 g/l, in particular 80 to 300 g/l. The content of microcapsules is in most cases 20 to 70% by weight, preferably 30 to 55% by weight, based on the agrochemical formulation. The aqueous solution in most cases comprises at least 10% by weight, preferably at least 30% by weight and in particular at least 60% by weight, of water.

Furthermore, the agrochemical formulations can also comprise auxiliaries customary for crop protection compositions, the choice of auxiliaries being governed by the specific application form and/or the active ingredient.

Examples of suitable auxiliaries are solvents, surface-active substances (such as further solubilizers, protective colloids, wetting agents and adhesives), organic and inorganic thickeners, bactericides, antifreezes, antifoams, optionally dyes and stickers (e.g. for seed treatment).

Suitable solvents are water, organic solvents such as mineral oil fractions of moderate to high boiling point, such as kerosene and diesel oil, also coal tar oils, and oils of vegetable or animal origin, aliphatic, cyclic and aromatic hydrocarbons, e.g. paraffins, tetrahydronaphthalene, alkylated naphthalenes and derivatives thereof, alkylated benzenes and derivatives thereof, alcohols such as methanol, ethanol, propanol, butanol and cyclohexanol, glycols, ketones such as cyclohexanone, gamma-butyrolactone, dimethyl fatty acid amides, fatty acids and fatty acid esters and strongly polar solvents, e.g. amines such as N-methylpyrrolidone. In principle, it is also possible to use solvent mixtures, and also mixtures of the aforementioned solvents and water.

Suitable surface-active substances (adjuvants, wetting agents, adhesives, dispersants or emulsifiers) are the alkali metal, alkaline earth metal, ammonium salts of aromatic sulfonic acids, e.g. of lignosulfonic acid (Borresperse® grades, Borregaard, Norway), phenolsulfonic acid, naphthalenesulfonic acid (Morwet® grades, Akzo Nobel, USA) and dibutylnaphthalenesulfonic acid (Nekal® grades, BASF, Germany), and also of fatty acids, alkyl- and alkylarylsulfonates, alkyl, lauryl ether and fatty alcohol sulfates, and also salts of sulfated hexa-, hepta- and octadecanols, and also of fatty alcohol glycol ethers, condensation products of sulfonated naphthalene and its derivatives with formaldehyde, condensation products of naphthalene or of naphthalenesulfonic acids with phenol and formaldehyde, polyoxyethylene octylphenol ether, ethoxylated isooctyl-, octyl- or nonyiphenol, alkylphenyl, tributylphenyl polyglycol ethers, alkylaryl polyether alcohols, isotridecyl alcohol, fatty alcohol ethylene oxide condensates, ethoxylated castor oil, polyoxyethylene or polyoxypropylene alkyl ethers, lauryl alcohol polyglycol ether acetate, sorbitol ester, lignosulfite waste liquors, and also proteins, denatured proteins, polysaccharides (e.g. methylcellulose), hydrophobically modified starches, polyvinyl alcohol (Mowiol® grades, Clariant, Switzerland), polycarboxylates (Sokalan® grades, BASF, Germany), polyalkoxylates, polyvinylamine (Lupamin® grades, BASF, Germany), polyethylenimine (Lupasol® grades, BASF, Germany), polyvinylpyrrolidone and copolymers thereof.

Examples of thickeners (i.e. compounds which confer modified flow behavior to the composition, i.e. high viscosity in the resting state and low viscosity in the agitated state) are polysaccharides, and also organic and inorganic layered minerals such as xanthan gum (Kelzan®, CP Kelco, USA), Rhodopol® 23 (Rhodia, France) or Veegum® (R.T. Vanderbilt, USA) or Attaclay® (Engelhard Corp., NJ, USA).

For stabilization, bactericides can be added to the composition. Examples of bactericides are those based on dichlorophen and benzyl alcohol hemiformal (Proxel® from ICI or Acticide® RS from Thor Chemie and Kathon® MK from Rohm & Haas), and also isothiazolinone derivatives such as alkylisothiazolinones and benzisothiazolinones (Acticide® MBS from Thor Chemie). Examples of suitable antifreezes are ethylene glycol, propylene glycol, urea and glycerol. Examples of antifoams are silicone emulsions (such as e.g. Silikon® SRE, Wacker, Germany or Rhodorsil®, Rhodia, France), long-chain alcohols, fatty acids, salts of fatty acids, organofluorine compounds and mixtures thereof.

The agrochemical formulation according to the invention is in most cases diluted prior to use in order to produce the so-called tank mix. Of suitability for the dilution are mineral oil fractions of moderate to high boiling point, such as kerosene or diesel oil, also cool tar oils, and also oils of vegetable or animal origin, aliphatic, cyclic and aromatic hydrocarbons, e.g. toluene, xylene, paraffin, tetrahydronaphthalene, alkylated naphthalenes or derivatives thereof, methanol, ethanol, propanol, butanol, cyclohexanol, cyclohexanone, isophorone, strongly polar solvents, e.g. dimethyl sulfoxide, N-methylpyrrolidone or water. Preference is given to using water. The diluted composition is usually applied by spraying or misting. Oils of various types, wetting agents, adjuvants, herbicides, bactericides, fungicides can be added to the tank mix directly prior to application (tank mix). These agents can be admixed into the compositions according to the invention in the weight ratio 1:100 to 100:1, preferably 1:10 to 10:1. The pesticide concentration in the tank mix can be varied within relatively large ranges. In general, they are between 0.0001 and 10%, preferably between 0.01 and 1%. When used in crop protection, the application rates are between 0.01 and 2.0 kg of active ingredient per ha depending on the nature of the desired effect.

The present invention also relates to the use of the microcapsules according to the invention for controlling phytopathogenic fungi and/or undesired plant growth and/or undesired insect or mite infestation and/or for regulating the growth of plants, where the microcapsules are allowed to act on the pests in question, their habitat or the plants to be protected from the pest in question, the soil and/or on undesired plants and/or the useful plants and/or their habitat.

The present invention offers highly diverse advantages: the microcapsules release the pesticide in a very uniform manner. The pesticide is released over several days or weeks. The release lasts longer than in the case of comparable microcapsules which also use divinyl monomers as crosslinker in addition to the polyvinyl monomers. The microcapsules are easy to prepare. They are readily compatible for agrochemical application. The microcapsules allow high loading with pesticide. As a result of the crosslinking with polyvinyl monomers, the microcapsules have very good mechanical stability (e.g. during stirring), and so the pesticide is not released prematurely as early as during preparation in the tank mix with stirring, but only slowly following application.

The examples below are intended to illustrate the invention in more detail without limiting it.

### EXAMPLES

Atlas® G 5000: Polyalkylene glycol ether, HLB value 17, commercially available from Uniquema.
Atlox® 4913: A methyl methacrylate graft copolymer (reaction product of methyl methacrylate, methacrylic acid and methoxy-PEG-methacrylate), 33% by weight of polymer, 33% by weight of propylene glycol, 1% by weight of xylene, 33% by weight of water (commercially available from Uniquema).
Attaflow® FL: Attapulgite thickener, commercially available from BASF.
Mowiol®: Hydrolyzed polyvinyl alcohol, viscosity 12.5-17.5 mPa·s (DIN 53015), commercially available from Kuraray
Solvesso® 200: Technical-grade mixture of aromatic hydrocarbons, aromatics content >99% by volume (ASTM D1319), IBP (Initial Boiling Point) 232° C., DP (Decomposition Point) 277° C. (in each case in accordance with ASTM D86), commercially available from Exxon Mobil.
MMA Methyl methacrylate
MAA Methacrylic acid
PETIA A technical-grade mixture of tri- and tetraacrylate of pentaerythritol
PMMA Polymethyl methacrylate

Unless stated otherwise, the percentages in the examples are percentages by weight. The particle size of the microcapsule powder was determined using a Malvern Particle Sizer model 3600E in accordance with a standard measurement method which is documented in the literature.

Determination of the evaporation rate: for the pretreatment, 2 g of the microcapsule dispersion were dried in a small metal dish at 105° C. for two hours in order to remove any residual water. The weight (mₒ) was then determined. After heating for one hour at 180° C. and cooling, the weight (m₁) was again determined. The weight difference (m₀-m₁), based on m₀ and multiplied by 100 gives the evaporation rate in %. The lower the value, the tighter the microcapsules. It must be ensured here that comparisons in the evaporation rate should always be carried out with comparable capsule sizes and stabilizer systems.

### Example 1

The water phase was initially introduced at 40° C.; feeds 1 and 2 were dispersed into this using a high-speed dissolver stirrer at 3500 rpm. Addition 1 was added to the emulsion with stirring using an anchor stirrer and the mixture was heated to 70° C. over the course of 60 minutes, and to 85° C. over the course of a further 120 minutes. With stirring, feed 1 was metered into the resulting microcapsule dispersion over 90 minutes at 90° C. and then the mixture was stirred for 2 hours at this temperature. Feed 3 was then added, the mixtures cooled to room temperature and feed 4 was added over the course of 80 min. This gave a microcapsule dispersion with an average particle size of D[4.3]=6.03 μm and a solids content of 42.05%.

Water phase:
220 g of water
95 g of a 5% strength by weight aqueous solution of methylhydroxypropylcellulose (viscosity of 90-125 mPas, Brookfield, 2% by weight, 20° C., 20 rpm)
23.8 g of a 10% strength by weight aqueous solution of polyvinyl alcohol (completely hydrolyzed, viscosity 12.5-17.5 mPas (DIN 53015))
1.1 g of a 2.5% strength by weight aqueous sodium nitrite solution

Addition 1
0.35 g of a 75% strength solution of t-butyl perpivalate in aliphatic hydrocarbons
0.43 g of water

Feed 1:
88 g of metazachlor
132 g of Solvesso 200

Feed 2:
7.8 g of n-butyl acrylate
10.2 g of PETIA
7.8 g of methacrylic acid

Feed 3:
2.7 g of a 10% strength by weight aqueous t-butyl hydroperoxide solution

Feed 4:
0.15 g of ascorbic acid
14.0 g of water

### Example 2

The procedure was analogous to example 1, except feed 2 consisted of the following components:

Feed 2:
7.8 g of methyl methacrylate
10.2 g of PETIA
7.8 g of methacrylic acid

This gave a microcapsule dispersion with an average particle size of D[4,3]=6.04 μm and a solids content of 42.05%.

### Example 3

The procedure was analogous to example 1, except feed 2 consisted of the following components:

Feed 2:
16.5 g of methyl methacrylate
22.0 g of pentaerythritol triacrylate (PETIA)
16.5 g of methacrylic acid

At the end, the mixture was neutralized with aqueous sodium hydroxide solution. This gave a microcapsule dispersion with an average particle size of 4.84 μm (D4,3) and a solids content of 45.76%. The evaporation rate at 130° C. (1 h) was 4.3%.

### Example 3

The procedure was analogous to example 1, except feed 2 consisted of the following components:

Feed 2:
5.16 g of methyl methacrylate
10.32 g of pentaerythritol triacrylate (PETIA)
10.32 g of methacrylic acid

At the end, the mixture was neutralized with aqueous sodium hydroxide solution. This gave a microcapsule dispersion with an average particle size of 6.71 μm (D4,3) and a solids content of 42.45%. The evaporation rate at 130° C. (1 h) was 13.5%.

### Example 4 (Comparative Example, Not According to the Invention)

The procedure was analogous to example 1, except in feed 2 pentaerythritol triacrylate (PETIA) was replaced by the same amount of butanediol diacrylate. This gave a microcapsule dispersion with an average particle size of D[4,3]=7.60 μm and a solids content of 42.05%.

### Example 5 (Comparative Example, Not According to the Invention)

The procedure was analogous to example 2, except in feed 2 pentaerythritol triacrylate (PETIA) was replaced by the same amount of butanediol diacrylate. This gave a microcapsule dispersion with an average particle size of D[4,3]=8.02 μm and a solids content of 42.05%.

### Example 6 (Comparative Example, Not According to the Invention)

The procedure was analogous to example 4, except in feed 2 pentaerythritol triacrylate (PETIA) was replaced by the same amount of butanediol diacrylate. This gave a microcapsule dispersion with an average particle size of 6.61 μm (D4,3) and a solids content of 42.07%. The evaporation rate at 130° C. (1 h) was 30.18%.

### Example 7

### Release of the Pesticide

An amount of the microcapsule dispersion from the aforementioned examples which comprised 300 mg of metazachlor was weighed in and topped up to 1.0 l with distilled water (=ca. 75% of the maximum soluble amount of metazachlor in 1 l of water) and stirred at room temperature. Here, good mechanical stability was exhibited since no metazachlor was released from stirring, as the very low starting values in tables 1-4 indicate.

In each case 5 ml of the resulting diluted mixture was removed at different time intervals and was filtered over a 0.22 μm filter and the metazachlor content was determined photometrically by means of UV-VIS spectroscopy with the help of a calibration curve. In order to make sure that no impurity disturbed the measurement, the absorption was determined at different wavelengths. The content of metazachlor in the aqueous solution determined in this way is summarized in table 1. The values show how much metazachlor was released from the microcapsules into the aqueous phase.

TABLE 1

| | Example 5 | Comparative example 9 |
|---|---|---|
| Time [h] | Release [%] | Release [%] |
| 0.5 | 10 | 86 |
| 1 | 12 | 92 |
| 2 | 13 | 98 |
| 4 | 17 | 100 |
| 8 | 19 | 100 |
| 24 | 26 | 100 |
| 48 | 26 | 100 |
| 72 | 29 | — |
| 192 | 50 | 100 |
| 384 | 58 | — |
| 744 | 68 | — |
| 1536 | 76 | — |

TABLE 2

| | Example 6 | Comparative example 10 |
|---|---|---|
| Time [h] | Release [%] | Release [%] |
| 0.5 | — | 19 |
| 1 | 1.3 | 24 |
| 4 | 1.6 | 36 |
| 8 | 1.9 | 40 |
| 24 | 2.3 | 46 |
| 48 | 2.6 | 54 |
| 192 | 3.7 | 76 |
| 384 | 5.0 | 83 |
| 792 | 5.1 | — |

TABLE 3

| | Example 8 | Comparative example 11 |
|---|---|---|
| Time [h] | Release [%] | Release [%] |
| 1 | 10 | 22 |
| 4.5 | 13 | 36 |
| 8 | 14 | 43 |
| 24 | 16 | 56 |
| 96 | 27 | 81 |
| 192 | 24 | 85 |
| 360 | 29 | 92 |
| 768 | 41 | 100 |
| 1536 | 50 | — |

TABLE 4

| | | Example 7 |
|---|---|---|
| Time [h] | Time [days] | Release [%] |
| 4 | 0.17 | 4 |
| 7 | 0.29 | 5 |
| 24 | 1 | 6 |
| 48 | 2 | 7 |
| 120 | 5 | 12 |
| 192 | 8 | 10 |
| 384 | 16 | 11 |
| 792 | 33 | 27 |
| 1536 | 64 | 40 |
| 3072 | 128 | 49 |

### Example 8

The microcapsules A and B were prepared with the concentrations according to table 5. The water phase comprising water, protective colloid and sodium nitrile was prepared. The oil phase was prepared by dissolving pyraclostrobin in Solvesso at elevated temperature, and then adding it to the water phase with stirring. The monomers were then added. The two-phase mixture was stirred at 70° C. for 30 min and cooled to 50° C. The resulting emulsion was admixed with t-butyl perpivalate with stirring and heated at 70° C. for 2 h and then held at 85° C. for 1.5 h. t-butyl hydroperoxide and ascorbic acid were then added over the course of 60 min while the mixture was cooled to 20° C. The suspension of pyraclostrobin-containing microcapsules obtained in this way could be further used without further work-up.

TABLE 5
Formulations (concentration in g/l)

| | A | B |
|---|---|---|
| Pyraclostrobin | 250 | 250 |
| MMA | 24 | 19.2 |
| MAA | 24 | 19.2 |
| PETIA | 32 | 25.6 |
| Ascorbic acid | 0.1 | 0.08 |
| Atlas G 5000 | 0 | 6.64 |
| Atlox 4913 | 0 | 6.64 |
| Attaflow FL | 0 | 4.28 |
| Antifoam | 0 | 0.22 |
| Mowiol | 321.8 | 257.4 |
| Sodium nitrite | 2.8 | 2.24 |
| Solvesso 200 | 64 | 51.2 |
| t-Butyl peroxypivalate | 0.57 | 0.46 |
| t-Butyl hydroperoxide | 18.4 | 14.72 |
| Water | ad 1000 ml | ad 1000 ml |

1-15. (canceled)

16. An agrochemical formulation comprising microcapsules, where the microcapsules are suspended in aqueous solution, and
where the microcapsules comprise a pesticide-containing capsule core and a capsule wall,
where the capsule wall is constructed from
30 to 90% by weight of one or more C₁-C₂₄-alkyl esters of acrylic acid or of methacrylic acid, acrylic acid, methacrylic acid or maleic acid (monomers I),
10 to 70% by weight of one or more polyvinyl monomers (monomer II), and
0 to 30% by weight of one or more further monomers (monomer III), which are different from the monomers I and II and which comprise at most 5.0% by weight of divinyl monomers,
in each case based on the total weight of the monomers,
where the capsule core comprises a nonpolar solvent, and
where the weight ratio of nonpolar solvent to pesticide is in the range 1:20 to 20:1.

17. The formulation according to claim 16, where monomer III is selected from the group consisting of itaconic acid, maleic anhydride, 2-hydroxyethyl acrylate and methacrylate, acrylamido-2-methylpropanesulfonic acid, methacrylonitrile, acrylonitrile, methacrylamide, N-vinylpyrrolidone, N-methylolacrylamide, N-methylolmethacrylamide, dimethylaminoethyl methacrylate and diethylaminoethyl methacrylate.

18. The formulation according to claim 16, where monomer I comprises both C₁-C₂₄-alkyl esters of acrylic acid and methacrylic acid (monomers Ia) and further comprises one or more unsaturated C₃-C₄-carboxylic acid (monomers Ib).

19. The formulation according to claim 18, where the weight ratio of monomer Ia to monomer Ib is in the range from 10:1 to 1:10.

20. The formulation according to claim 16, wherein the polyvinyl monomer is selected from the group consisting of trimethylolpropane triacrylate and trimethacrylate, pentaerythritol triallyl ether, pentaerythritol tetraallyl ether, pentaerythritol triacrylate and pentaerythritol tetraacrylate, and their technical-grade mixtures.

21. The formulation according to claim 16, where the nonpolar solvent is soluble in water at 20° C. to at most 10% by weight.

22. The formulation according to claim 21, where the weight ratio of nonpolar solvent to pesticide is in the range 1:10 to 8:1.

23. The formulation according to claim 16, where the weight ratio of capsule core to capsule wall is in the range from 50:1 to 1:1.

24. The formulation according to claim 16, where the pesticide is present in dissolved form in the capsule core.

25. The formulation according to claim 16, where the pesticide dissolves to give a clear solution at 25° C. to at least 10 g/l in an aromatic hydrocarbon mixture with an initial boiling point of at least 225° C.

26. The formulation according to claim 16 comprising 20 to 70% by weight of microcapsules, based on the agrochemical formulation.

27. The formulation according to claim 16, where the content of pesticide which is present in the pesticide-containing capsule core is 10 to 600 g per liter of agrochemical formulation.

28. A process for preparing the microcapsules according to claim 16, comprising preparing an oil-in-water emulsion from monomers, free-radical initiator, protective colloid and the pesticide to be encapsulated, and triggering the polymerization of the monomers by heating and, where necessary, controlling the polymerization by further increasing the temperature.

29. The process according to claim 28, where, after the capsule formation, an afterpolymerization is triggered with salts of peroxodisulfuric acid as free-radical initiator.

30. A method for controlling phytopathogenic fungi, undesired plant growth, or undesired insect or mite infestation, or for regulating the growth of plants, comprising allowing the formulation of claim 16 to to act on the pests, their habitat or the plants to be protected from the pest, the soil or on the undesired plants, the useful plants, or their habitat.

31. The method of claim 30, wherein monomer III is selected from the group consisting of itaconic acid, maleic anhydride, 2-hydroxyethyl acrylate and methacrylate, acrylamido-2-methylpropanesulfonic acid, methacrylonitrile, acrylonitrile, methacrylamide, N-vinylpyrrolidone, N-methylolacrylamide, N-methylolmethacrylamide, dimethylaminoethyl methacrylate and diethylaminoethyl methacrylate.

32. The method of claim 30, wherein monomer I comprises both C₁-C₂₄-alkyl esters of acrylic acid and methacrylic acid (monomers Ia) and further comprises one or more unsaturated C₃-C₄-carboxylic acid (monomers Ib).

33. The method of claim 32, wherein the weight ratio of monomer Ia to monomer Ib is in the range from 10:1 to 1:10.

34. The method of claim 30, wherein the polyvinyl monomer is selected from the group consisting of trimethylolpropane triacrylate and trimethacrylate, pentaerythritol triallyl ether, pentaerythritol tetraallyl ether, pentaerythritol triacrylate and pentaerythritol tetraacrylate, and their technical-grade mixtures.

35. The method of claim 30, wherein the nonpolar solvent is soluble in water at 20° C. to at most 10% by weight.
